(19) United States
(12) Patent Application Publication
(10) Pub. No.: US 2020/0367632 A1
(43) Pub. Date: Nov. 26, 2020

(54) Clipping Device with Integrated Finger Trap

(71) Applicant: Westa LLC, Mill Valley, CA (US)

(72) Inventors: Michael Friedman, Mill Valley, CA (US); Craig Dennis, Golden, CO (US)

(73) Assignee: Westa LLC, Mill Valley, CA (US)

(21) Appl. No.: 16/877,973

(22) Filed: May 19, 2020

Related U.S. Application Data
(60) Provisional application No. 62/852,221, filed on May 23, 2019.

(51) Int. Cl. A45F 5/02; A45C 11/00; H04M 1/04

(52) U.S. Cl. CPC A45F 5/021; A45C 11/00; A45F 2200/0516; A45C 2011/002; H04M 1/04

(57) ABSTRACT

A clipping device for securing an attached device is provided. The attached device is clipped to a clip target, such as a pocket edge, holster, utility webbing, belt strap, or other element commonly used to secure an attached device using a clipping device. A clip in the clipping device is configured to maintain tension against a clipping surface. To secure the device, the clip target is inserted between the clip and the clipping surface. The clipping device includes an integrated finger trap configured to facilitate manipulation of the attached device when the attached device is unclipped from the clip target. The attached device can be a smartphone and the clipping device can include a case for the smartphone as part of its structure.

### CROSS REFERENCE TO RELATED APPLICATION

This application claims the benefit of U.S. Provisional Patent Application No. 62/852,221, filed May 23, 2019, which is incorporated by reference herein in its entirety for all purposes.

### BACKGROUND

Many accessories for facilitating manipulation of personal devices, such as mobile cellphones, are available on the market. On trend actions such as texting, video calling, taking selfies or vlogging have created a demand for accessories that ensure a firm grip of the device when in use. Therefore, accessories that aid in holding devices in a secure position, such as phone pop-out holders or ring holders, have gained popularity amongst users because of their convenient function. However, known accessories for securely holding personal devices fail to provide a practical experience when the user is carrying but not using the device, because they interfere when placing the device in a pocket or bags with dedicated gaps for holding personal devices, such as cellphones, that are designed with a standard width. Thus, a device that ensures a secure grip for user manipulation while providing a convenient structure for putting the device away when not being used is desirable.

### SUMMARY

A clipping device for securing an attached device when the attached device is clipped to a clip target with an integrated finger trap configured to facilitate manipulation of the attached device when the attached device is unclipped from the clip target are disclosed herein. In specific embodiments of the invention, the clipping device includes a clip configured to maintain tension against a clipping surface to clip a clip target between the clip and clipping surface. The clip target may be a pocket edge, holster, utility webbing, belt strap, or other element commonly used to secure an attached device using a clipping device. In specific embodiments of the invention, the finger trap is configured to require only a single finger for stabilizing the attached device while allowing for manipulation of the attached device with the remaining fingers. In specific embodiments of the invention, the clipping device includes a clip and a smartphone case, and the attached device is a smartphone.

### BRIEF DESCRIPTION OF THE DRAWINGS

FIG. 1 is a line drawing of a clipping device that is attached to a phone case, and an exploded diagram of that clipping device, that are in accordance with specific embodiments of the invention disclosed herein.

FIG. 2 is a line drawing of a clipping device with an integrated finger trap that defines an enclosure volume in accordance with specific embodiments of the invention disclosed herein.

FIG. 3 is a line drawing of a clipping device with a depression in the clip in accordance with specific embodiments of the invention disclosed herein.

FIG. 4 is a line drawing of several variations of the surface and shape of a finger trap in accordance with specific embodiments of the invention disclosed herein.

FIG. 5 is a line drawing of a side and axonometric view of a clipping device with a sloped cantilever and an integrated finger trap in accordance with specific embodiments of the invention disclosed herein.

FIG. 6 is a line drawing of a side and axonometric view of a clipping device with a depression and an integrated finger trap in accordance with specific embodiments of the invention disclosed herein.

FIG. 7 is a line drawing of various views of a case and anchor that form a single unitary element and a separate clip to be attached thereto in accordance with specific embodiments of the invention disclosed herein.

FIG. 8 is a line drawing of various views of a case and clip where the clip is attached at various mounting locations on the case in accordance with specific embodiments of the invention disclosed herein.

FIG. 9 is a line drawing of different clip designs to illustrate the depth at which the attached device can be placed below the top surface of a clipping target which are in accordance with specific embodiments of the invention disclosed herein.

FIG. 10 is a line drawing of two views of a hinged clip design in which the finger trap is rotated around the hinge in accordance with specific embodiments of the invention disclosed herein.

FIG. 11 is a line drawing of a close-up of the views in FIG. 10 from a side perspective.

FIG. 12 is a line drawing of a clipping device that is configured to attach to a mounting device in accordance with specific embodiments of the invention disclosed herein.

### DETAILED DESCRIPTION

Specific methods and systems associated with securing and manipulating devices in accordance with the summary above are provided in this section. The methods and systems disclosed in this section are nonlimiting embodiments of the invention, are provided for explanatory purposes only, and should not be used to constrict the full scope of the invention

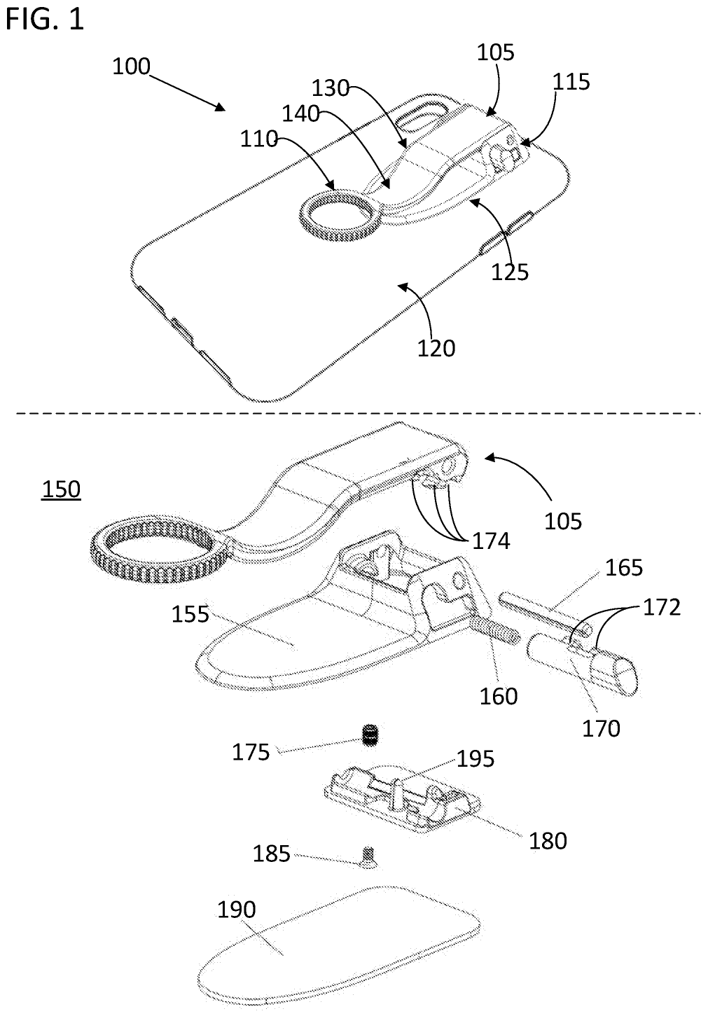

FIG. 1 is an illustration of a clipping device 100 for a smartphone in accordance with specific embodiments of the present invention. In the illustration, the clipping device 100 includes a clip 105 with an integrated finger trap 110, a clip anchor 115, and a case 120 for the smartphone. To secure the device, the clip target (not shown) can be inserted between the clip 105 and a clip surface formed by an alternative portion of the device. In this embodiment, the back surface of the smartphone is covered by a case 120 to which the clipping device can be adhered using an adhesive. The adhesive could be provided on the back side of a structure extending from the anchor 115, such as structure 125, as will be described with reference to the exploded diagram 150. Structure 125 and anchor 115 could form a base structure for a clip locking mechanism. In alternative embodiments the case 120 could form a clipping surface for the clip 105. In other embodiments, the clipping surface can be a holster of the clipping device. As used herein, the term clipping surface can refer to any surface with which the clip 105 cooperates to maintain tension against a clipped element. The clipping surface can be a surface of the attached device itself as not all embodiments of the invention will include a case or equivalent structure. The clipping surface can be part of a holster that forms part of the clipping device and is configured to maintain tension against a clipping target in combination with the clip.

The clip 105 in FIG. 1 includes an elastic cantilever 130 extending away from the anchor 115 and attached to the anchor 115 at a hinge. In alternative embodiments, the cantilever can be attached to the anchor 115 using screws. The cantilever can be attached to the anchor 115 using three screws or any number of screws as the design allows. The cantilever 130 and integrated finger trap 110 are integrated in that they can be a single unitary element formed of the same material, such as metal or plastic. In turn, in specific embodiments of the invention the anchor 115 and case 120 can be a single unitary element of polymer or any other suitable material formed using an injection mold process. The illustrated clip 105 maintains tension against the clipping surface to secure the smartphone while providing a secure finger trap 110 for facilitating manipulation of the smartphone. The finger trap 110 also allows for quick unclipping of the device from the clip target by providing an easy grip for unclipping the clip. The illustrated clip 105 maintains tension in the direction of the clipping surface via the elastic cantilever 130 and anchor 115. The clip 105 includes a depression 140 on the elastic cantilever 130. The depression 140 is in the direction of the clipping surface and thereby strengthen the clipping force for a given clipping target width.

The finger trap 110 in FIG. 1 is a textured ring. The ring allows for a user to utilize a single finger to secure the attached device while allowing for manipulation of the attached device with the remaining fingers. The finger trap 110 is a complete enclosure that does not have any breaks which would have allowed a finger to slip out of the ring in a lateral direction. The finger trap is also spaced apart from the back surface of the case 120 to form a pit for the finger trap 110 and provide further stability for holding the device with a single finger. The depression 140 allows for the finger trap 110 to be spaced apart from the clipping surface while still providing adequate tension to the clip target.

FIG. 1 also provides an exploded diagram 150 of the clipping device 100 in accordance with specific embodiments of the present invention. The components of the mechanism include a base 155, a spring 160, a spring pin 165, a plunger 170, a bottom insert 180, a screw 185, a threaded insert 175, and a pad 190, which can be an adhesive pad. The hinge mentioned above can be provided by spring pin 165 as it extends through both clip 105 and anchor 115. The illustrated clipping device 100 is configured such that the clip is locked in place by a lock and cannot swing along the hinge provided by spring pin 165 until plunger 170 is depressed. In this embodiment, the clip can also serve as a kickstand as the same lock maintains the clip in the open position as will be described below.

In specific embodiments of the invention in which the clip includes a hinge, different approaches can be applied so that the hinge does not weaken the grip of the clip. For example, the geometry of the clip should be selected so that the hinge is not located where the gripping force is applied. Alternatively or in combination, the clip can include a lock to keep the clip in a “locked closed” state in which the clip is prevented from swinging on the hinge by the lock unless desired. In embodiments in which the clip is hinged and includes a lock, the clipping device can alternatively or in combination be configured to maintain the clip in a “locked open” state so that it can serve as a kickstand. The clipping device could also be configured so that the same lock maintained the clip in the open state and the closed state.

The structure and operation of a clipping device with a hinge and lock in accordance with this disclosure can take on various forms, some of which are in accordance with exploded diagram 150 in FIG. 1. Clipping device 100 is illustrated as being in a locked closed state in which lock tabs 172 on plunger 170 are engaged with lock tabs 174 on clip 105. Subsequently, plunger 170 can be depressed against the tension of the spring 160. The plunger 170 can be guided linearly along a slot through which a post 195, attached to the bottom insert 180, is inserted. The plunger 170 can be further guided by resting on the bottom insert 180 via a mating surface, such as a mating cylindrical surface. The diameter of the plunger's 170 cylindrical body and the mating surface of bottom insert 180 can be designed to facilitate linear movement. With plunger 170 depressed, the lock tabs 172 and 174 are disengaged and the clip 105 is free to rotate around the axis which is defined by the spring pin 165. Once the clip 105 starts rotation, the depressed position of the plunger 170 is held in place without external force applied to plunger 170 until an “open” position is reached at a certain degree. In the illustrated device, that certain degree is 75 degrees. At this point, the spring 160 can be allowed to re-engage the lock tabs on the plunger 170 and clip 105 such that the clip is in a locked open state. The inverse procedure will then allow the clip to return to the locked close state.

In specific embodiments of the invention, in the locked closed state, post 195 on the bottom insert 180 can be inserted into a slide pocket of the plunger 170. This approach is specifically designed to mitigate the user forcibly lifting up the clip 105 without depressing the plunger 170, which means, without “unlocking” it. This interface between the post and slide pocket prohibits the rotation of the plunger 170 inside the mechanism. As such, post 195 can be referred to as an “anti-rotation” post. In specific embodiments of the invention, the lock tabs of the plunger 170 can nest inside the lock tabs of the clip 105 using drafted sidewalls. This forms a wedge between the lock tabs and allows for the mechanism to stay tight regardless of wear for the life of the product. This engineered-in tension is always held in place by the spring 160.

The components of a clipping device in accordance with this disclosure can comprise various materials some of which are provided as follows with reference to FIG. 1. For example, base 155 and bottom insert 180 can be made of any suitable material, such as a polymer material. In specific embodiments of the invention, the material used is nylon, which provides a balance of low-cost and strength, and allows for a plurality of color options. For example, base 155 and bottom insert 180 can be made of glass-filled nylon, which is known as a stronger polymer that combines short glass fibers within a matrix of a polymer material. Pad 190 can be an industrial adhesive, such as a double-sided transfer tape. Pad 190 can be, for example, a Very High Bond (VHB) two-sided adhesive tape. Plunger 170 can be made of any suitable material that provides the appropriate strength and appearance, such as aluminum. In specific embodiments of the invention, the material of plunger 170 is die-cast aluminum A380. In specific embodiments of the invention, the material of the clip 105 can also be die-cast aluminum A380. Spring pin 165 constitutes the pivot point of the mechanism and can be an off-the shelf pin, such as a steel spring pin. Spring 160, threaded insert 175 and screw 185 can also be off-the-shelf components made of any suitable material. For example, threaded insert 175 could be a brass insert.

A clipping device in accordance with this disclosure can be assembled using various methods, some of which are provided as follows with reference to exploded diagram 150. Base 155 can be secured together with pad 190 as a result of the adhesive properties of pad 190. Clip 105 can be secured to the base structure via spring pin 165. The bottom insert 180 can be held in place inside the structure of the base 155 on one side by a molded mating slot and on the other side by the screw 185. The screw 185 can be fastened into the threaded insert 175, which can in turn be co-molded into the base 155. Plunger 170 can be held in place by its conformance to bottom insert 180, the tension of the spring 160, and the force of the lock tabs of plunger 170 against base 155.

In specific embodiments of the invention, the finger trap can take on various forms. The finger trap can define an enclosed area. The finger trap can form at least a partial enclosure around the enclosed area. In specific embodiments of the invention, the partial enclosure does not have any breaks in excess of one centimeter. The breaks can be limited such that none of the breaks are larger than the depth of a slender human finger. The finger trap can form a complete enclosure around the enclosed area. The finger trap can be a ring surrounding an enclosed area comprised of a circular hole through the center of the ring. The finger trap can be two or more semicircles where one semicircle is integrated with the clip and one or more semicircles is attached to the clipping surface. The enclosed area can take on any shape such as a square, rectangle, or oval, and does not need to be regular or symmetrical.

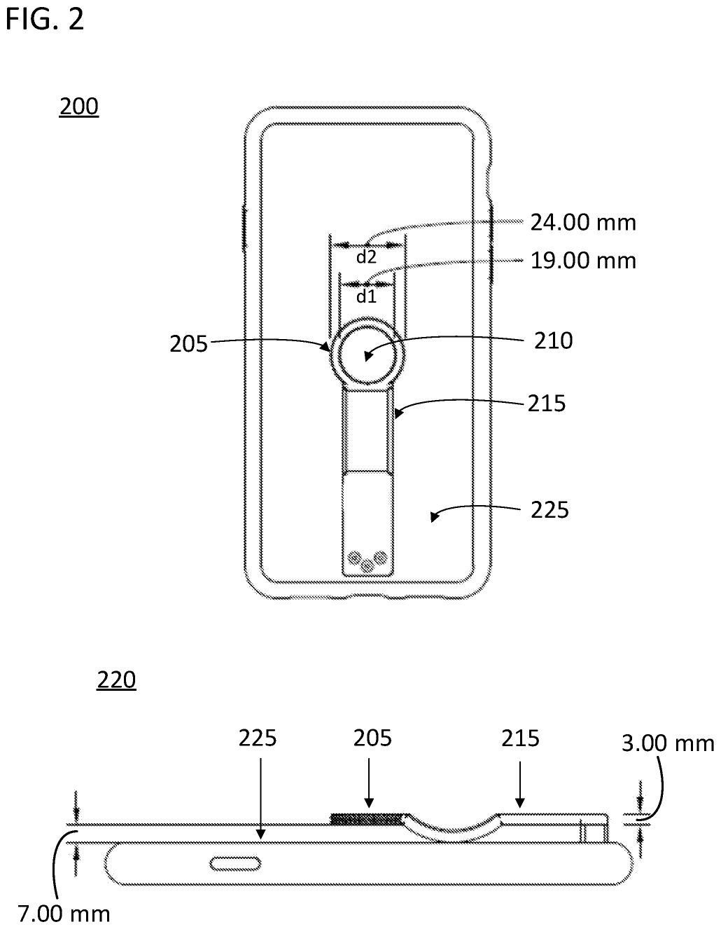

In specific embodiments of the invention, the enclosed area is beneficially sized such that a finger can pass into the area easily but not so large that the finger cannot find solid support against multiple portions of the trap. In specific embodiments of the invention the enclosed area can have a minimum cross section of at least 15 mm. As used herein the term minimum cross section refers to the distance of a line segment that begins on a perimeter of the enclosed area, proceeds through the center point of the enclosed area, and terminates on the perimeter of the enclosed area. If the enclosed area is asymmetrical the center point is the point that maximizes the mean squared distance to the perimeter of the enclosed area in all directions. In specific embodiments of the invention, the finger trap can be a ring with an inner diameter of at least 15 mm and an outer diameter of at least 20 mm. FIG. 2 provides an illustration of a specific embodiment of a clipping device 200 in accordance with this disclosure in which the finger trap 205 is a loop defining an enclosed area 210 via total enclosure. In the illustration, the inner diameter d1 of the ring is 19 mm and the outer diameter d2 is 24 mm.

In specific embodiments of the invention, the finger trap can include an enclosed volume defined by the enclosed area and a depth. The depth can be set by the distance between the clipping surface and a top surface of the finger trap. In alternative embodiments, the depth can be set by the distance between the attached device and the top surface of the finger trap. The depth is generally defined by the point at which the tip of the finger will rest when inserted into the trap which can be the clipping surface or a surface of the attached device. The enclosed volume can be a pit into which a finger can be placed. When placed in the trap, the tip of the finger can rest on the clipping surface or the attached device and simultaneously lay against a border of the finger trap. In specific embodiments of the invention, the enclosed volume is at least 0.7 centimeters deep from a top surface of the finger trap to the attached device or clipping surface. This depth has been found to provide sufficient stabilization for a finger placed in the trap and resting against the finger trap on its side. The embodiment illustrated in FIG. 2 also includes a side view 220 from which the dimensions of the enclosed volume can be seen. In the illustrated case, the clip 215 has a width of 3 mm and the finger trap 205 is spaced apart from the clipping surface 225 by 7 mm. As a result, the enclosed area has a depth of 10 mm which is well within the range suitable to provide adequate stability to a finger placed in the finger trap 205.

In specific embodiments of the invention, the clip can be configured to maintain tension towards a clipping surface in various ways. The clip can be configured to maintain tension towards a clipping surface using any approach known in the art as of the time of filing the present application. The clip can be an elastic cantilever that can be flexibly moved away from the clipping surface to engage with the clipping target, and then return towards the clipping surface via the elasticity of the cantilever. The clip can include a spring on a hinge of the clip. The clip can maintain tension towards the clipping surface via the force of the spring bringing a jaw of the clip down towards the clipping surface. The clip can be an alligator clip with the spring and a lever for opening the clip located proximate an anchor connected to the jaw.

In specific embodiments of the invention, the jaw or cantilever of the clip can be generally sloped down from an anchor point towards the clipping surface. The main region of tension supplied by the clip would, in these embodiments, be at the point at which the clip or jaw was at the closest point to the clipping surface. In specific embodiments, the jaw or cantilever will be in contact with the clipping surface at this point. The distal end of the jaw or cantilever can be configured to rest on the clipping surface or in a depression in the clipping surface configured to accept the jaw or cantilever.

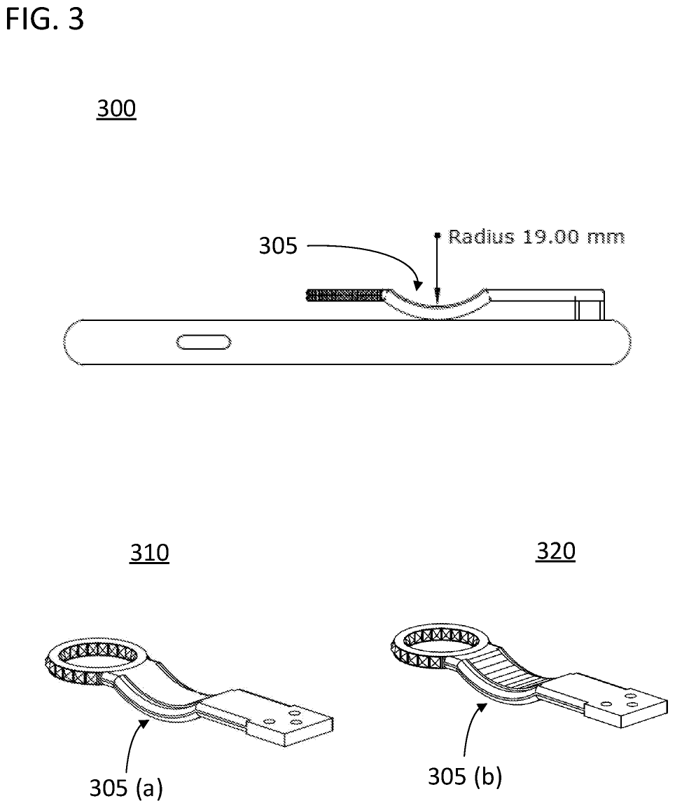

In specific embodiments of the invention, the jaw or cantilever of the clip can include a depression in the direction of the clipping surface. The clipping surface can include its own depression to receive the depression of the cantilever or jaw. The main region of tension supplied by the clip would, in these embodiments, be at the bottom of the depression in the clip. In specific embodiments of the invention, the depression can take on various characteristics. The depression can be designed to serve as a finger catch. The depression can be designed to have a large enough length for it to also support the insertion of a finger into the top side of the depression to afford a user with even more surfaces to use to grip the device. The depression can be a semicircle comprising at least 90 degrees of a circle having a radius of 20 mm. The depression can be smooth. In alternative approaches the depression can be textured to enhance grip stability. FIG. 3 illustrates an embodiment of a clipping device 300 in accordance with specific embodiments of the invention including a depression 305 in which the depression 305 is a semicircle comprising ninety degrees of a circle having a radius of 19 mm. FIG. 3 also shows axonometric views 310, 320 of the same depression 305 with (a) and without (b) texturing on the top surface of the depression 305 for serving as a textured or smooth grip finger catch.

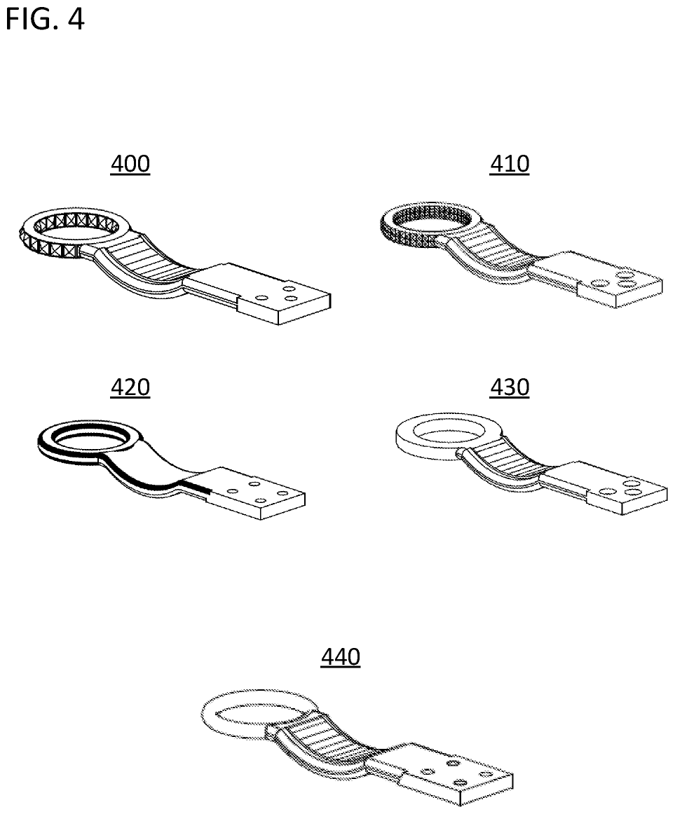

In specific embodiments of the invention, the enclosed area of the finger trap can take on various forms. Specific examples of these variations are provided in FIG. 4. As seen in the illustrated embodiments, the finger trap defines a circular enclosed area and completely encloses the enclosed area in each example. However, the variations exhibited by FIG. 4 are equally applicable to finger traps that trace non-circular paths and that are not complete enclosures. Ring 400 is an example of a textured finger trap. Ring 400 includes multiple dimples formed by a machining process operating on a smooth metal work piece. The texture can prevent slipping and provide a surer grip when holding the attached device. Ring 410 is an example of a knurled finger trap. Ring 410 provides a slightly less rough texture while still providing a sure grip. The knurling example provides certain benefits in that machine tools which create this type of pattern of texture are commonly available. Ring 440 is an example of a torus shaped finger trap. The torus shape provides a smoother feel and a more refined appearance than the textured example at the expense of a less secure grip. Ring 430 is an example of a cylindrically shaped finger trap. The cylindrical shape also provides a smooth feel and is somewhat easier to manufacture than the torus. Ring 420 is an example of a filleted finger trap. The filleted example provides a combination of flat surfaces for sure contact and rounded edges for comfort. These examples are non-limiting as many other surface treatments and materials can be applied to meet specific requirements for grip, comfort, and style.

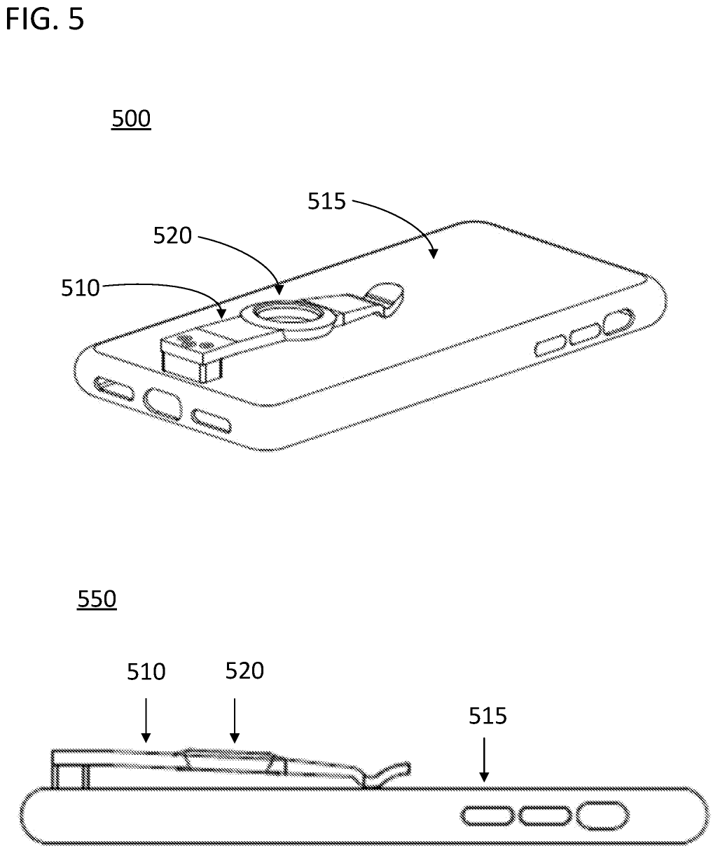

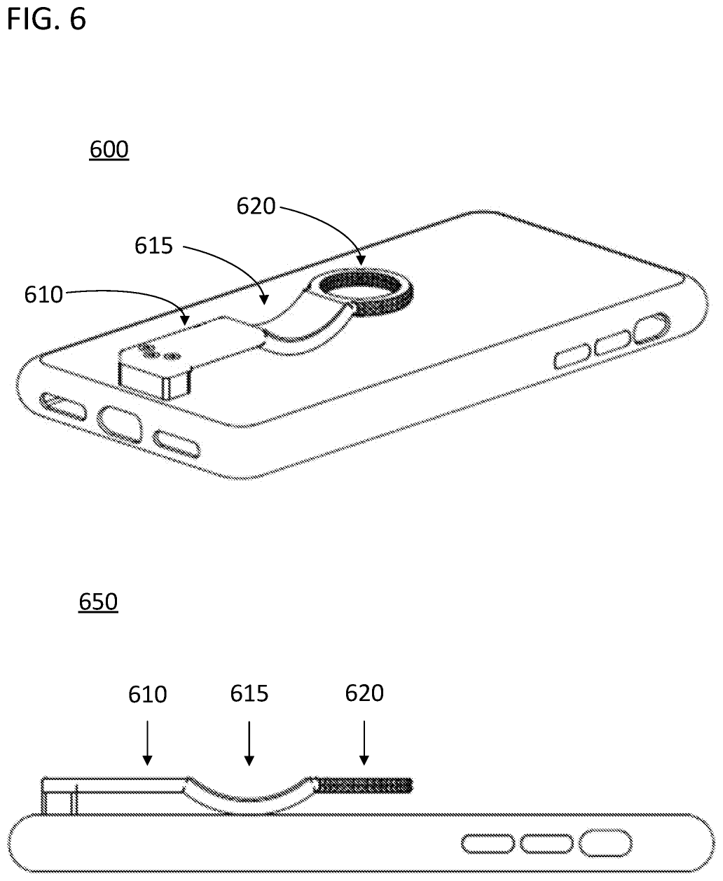

In specific embodiments of the invention, the finger trap and clip can be integrated in various ways. The finger trap and clip can be formed of a single unitary element such as being machined or stamped from a single work piece or shaped using additive manufacturing. The finger trap can also be a separate piece added to an excavated portion of the clip or attached to a solid surface of the clip. The finger trap can be located at the middle, top, or bottom of the clip relative to a clip anchor. However, in specific embodiments of the invention, the finger trap will be located at a given portion of the clip to ensure adequate spacing between the attached device or clipping surface and the finger trap. In particular, the finger trap can be placed on the clip to ensure that the finger trap is spaced apart from the attached device by at least 0.5 cm. In examples in which the distal end of the clip rests on the clipping surface or attached device, or is in closer proximity to the clipping surface or attached device, and the clip slants downward from the clip anchor, the finger trap can be located up the slope from the distal end in order to assure this spacing. For example, FIG. 5 illustrates an axonometric 500 and side 550 view of a clipping device in accordance with specific embodiments of the present invention, including a cantilevered clip 510 in which the cantilever rests on the clipping surface 515. As such, the finger trap 520 has been placed half-way up the cantilever 510 to assure adequate spacing to form a sufficient pit to secure a finger in the finger trap 520. Alternatively, if the clip includes a depression towards the clipping surface or attached device, the finger trap can be connected to the end of the clip. For example, FIG. 6 illustrates an axonometric 600 and side 650 view of a clipping device in accordance with specific embodiments of the present invention, including a cantilevered clip 610 with a depression 615 that extends towards the clipping surface, the depression 615 being larger than 0.5 cm to assure that the finger trap 620 forms a sufficiently deep pit.

In specific embodiments of the invention, the finger trap can be oriented relative to the clip in various ways. Furthermore, in specific embodiments of the invention the clip can include multiple finger traps, and each finger trap can include multiple enclosed areas and enclosed volumes having the characteristics described herein. For example, and as described above, one or more finger traps or enclosed areas can be positioned along the length of the clip or at the end of the clip. These one or more finger traps or enclosed areas can have their main surfaces oriented in parallel with the main surface of the clip, perpendicular to the main surface of the clip, or at a different angle relative to the main surface of the clip. As will be described in an example below, the one or more finger traps could also be hinged to allow for rotation through various angles relative to the main surface of the clip. The finger traps or enclosed areas could be tangentially connected, overlapping, or spaced apart. For example, two rings could be connected at their tangent and stacked vertically at the end of the clip or positioned along the length of the clip and oriented to have their main surfaces in parallel with the main surface of the clip.

In specific embodiments of the invention, the clip can be connected to an attached device in various ways. In specific embodiments of the invention, the clip can be directly attached to the attached device via screw holes in the attached device, adhesive, snaps, or some other means for attachment. In specific embodiments of the invention, the clip can be attached to the attached device via an anchor. The clip can be attached to the anchor and the anchor can be attached to the attached device using any combination of screws, snaps, adhesives, or other means for attachment. In specific embodiments of the invention, the attached device can include a case, and the clip can be attached to the attached device via the case either through a direct connection to the case or through an anchor attached to the case. For example, the case and clip can be a unitary element such as a continuous unitary element formed of a polymeric material produced by a compression molding process. The case can be a standard smartphone case configured to conformably latch to the attached device. As another example, the clip can be connected to an adhesive anchor that can be bonded to a case for the attached device or directly to the attached device. The adhesive anchor could have a removable cover for allowing an end user to bond the clip to the device of their choosing at the orientation of their choosing. The bond can be permanent or removable. In these embodiments, the clip and anchor could be a single unitary element formed by injection molding. As another example, the case can include an anchor to which the clip can be attached, and the case and anchor can be a unitary element while the clip is attached to the anchor using screws, snaps, or other fasteners. In these embodiments, the case and anchor could be polymeric while the clip is metallic. In any of the above embodiments, the clip could be stainless steel or titanium and be secured to polymeric screw holes in the case, anchor, or screw holes in the attached device using metallic screws.

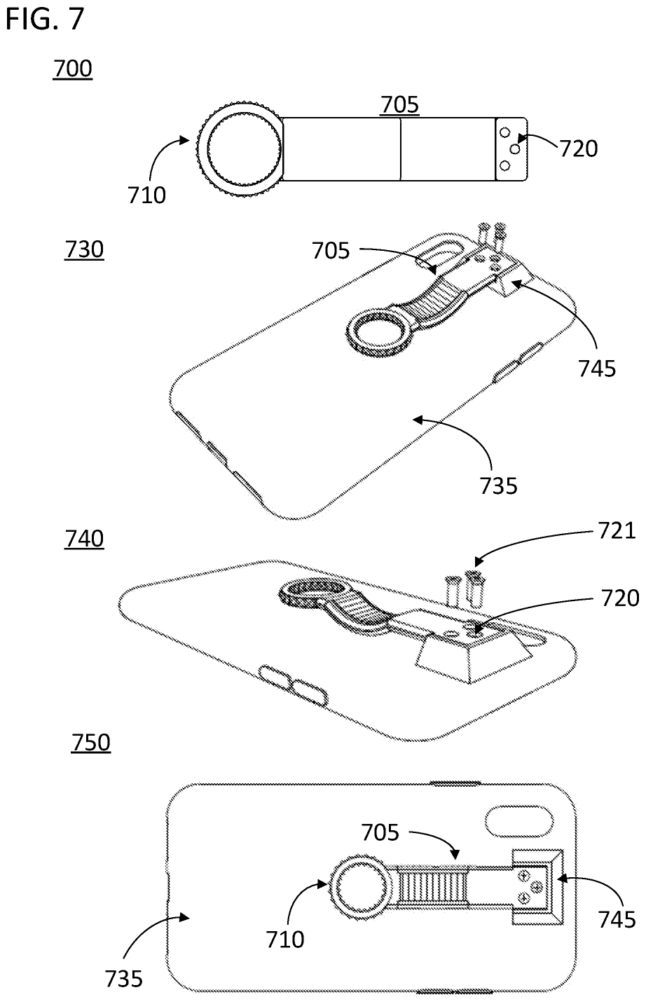

FIG. 7 provides an illustration of a clip 705 and integrated finger trap 710 in the form of a unitary element 700, such as a metallic element, having three screw holes 720. The illustration also includes views 730, 740 and 750 of a case 735 having an integrated anchor 745 with three threaded screw holes 720. The clip 705 can be attached to this anchor 745 as shown using screws 721, such as metallic screws. The illustrated anchor 745 can be polymeric and can form a unitary element along with the case 735. However, either the threaded screw holes 720 or the entire anchor 745 could be substituted with separable pieces, such as metallic pieces, attached to the case 735 using a bonding element, screws, snaps, or other fasteners.

In specific embodiments the invention in which the device is attached using a case, the case can include multiple anchors to which the clip can be alternatively fixed depending upon the preferences of the users. For example, the case could include different groupings of screw holes at different anchor points to allow a user to put the attached device in their pocket with alternative sides facing up, or to offset the device from center. If the attached device were a smartphone and the clipping target was a pocket, holster, bag, or the like, enabling a user to select different anchor points might allow them to face the main data connector or head phone jack of the smartphone up for easy access even when the device is secured. Allowing for multiple mounting orientations and locations would allow the same clipping device to work for the same user changing their mind about which portion of the device to have facing up, or for different devices having different locations for their data or audio ports.

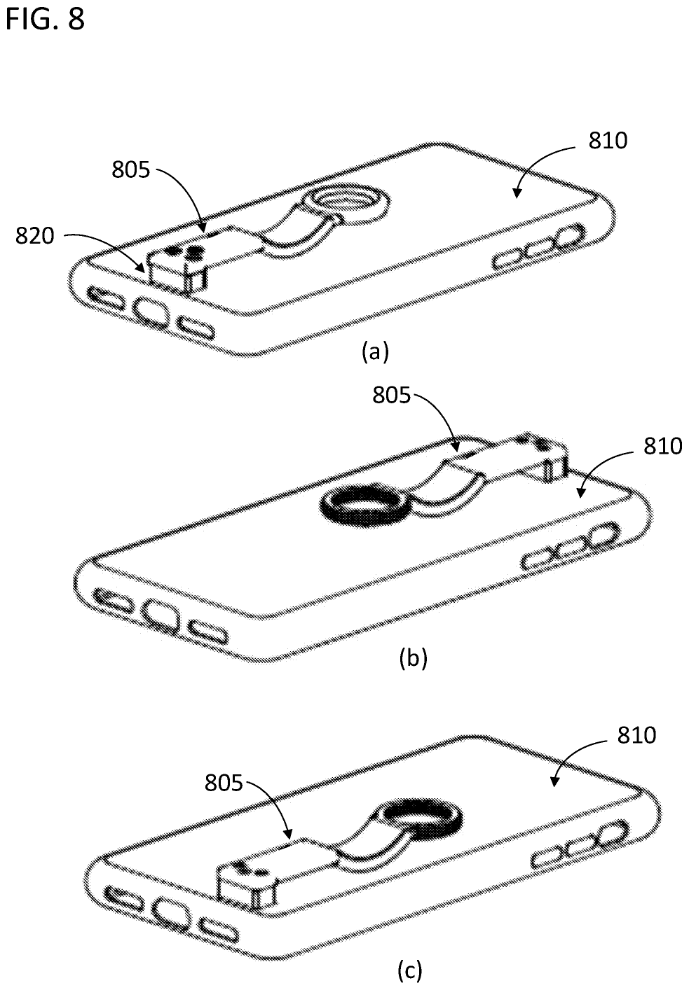

FIG. 8 provides an illustration of the same clip 805 being placed at different mounting locations on the same case 810. As a result, configurations (a) and (b) differ in the side of the smartphone that will be presented at the top of the clipping target for easy access even when the device is secured, and configuration (c) shows an example of a different customizable position the user can select according to the user preferences. In the illustration, the anchor 820 is a permanent fixture of the case 810. However, in alternative embodiments, the same case could have multiple collections of screw holes to allow a user to attach the clip to any of the positions shown in FIG. 8.

In embodiments in which the case and clip are not unitary elements, a user could be given the option to swap in different clips with different surfaces and clipping styles depending upon the application. The user could then use the same case for a belt clip, holster clip, and pocket clip, and numerous other variations. The characteristics of the clip and finger trap could likewise be altered by swapping out the clip from the case.

In specific embodiments of the invention, the clip and anchor can be configured to maximize the depth of the clip. In the example provided above in which the clip is attached with three screws the security provided by the three screws allows the anchor to take up minimal space to assure the attached device can be placed deep into the secured location relative to the clip. In another example, the clip could include a curve to deepen the extent to which the attached device can be secured. For example, the clip could include a curve that extends away from the clip anchor in one direction while the distal end of the clip extended off in an opposite direction. The radius of the curve could be greater than 3 cm and assure that the attached device was placed deep relative to a top side of the clipping target. The top side of the clipping target could be the edge of a pocket or top side of a holster.

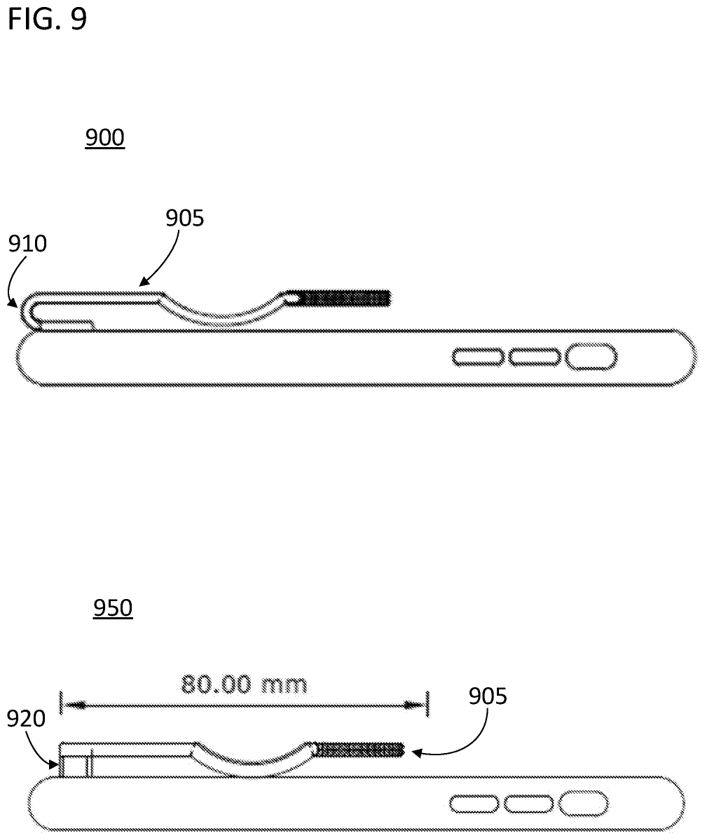

FIG. 9 provides an illustration of two configurations for assuring the attached device is deeply clipped. In the top example of FIG. 9 (configuration 900), the clip 905 includes a loop 910 that extends off in the opposite direction of the distal end of the clip 905. As a result, the top side of the clipping target will be nearly even with the top side of the attached device such that the entire attached device can be within an associated pocket or holster. In the lower example of FIG. 9 (configuration 950), the clip 905 is secured using three screws (not shown) that are roughly aligned into the plane of the page so that the anchor 920 is shallow having a length of less than 7 mm. As shown, the length of the clip 905 is also important for assuring a solid hold, and the clip 905 in both instances can be over 80 mm in length. In specific embodiments of the invention in accordance with the examples of FIG. 8, the clips length measured from the top surface of the clipping target when the attached device is secured is at least 70 mm.

In specific embodiments of the invention, the clipping device includes a hinge connecting the finger trap to the clip. The finger trap can then rotate relative to the clip. In specific embodiments of the invention, the finger trap could rotate to provide the user with multiple potential orientations in which to rest their finger. In specific embodiments of the invention, the rotating finger trap could also be configured to lock the device into place when secured. For example, in embodiments in which the clipping surface was part of the clipping device, the clipping surface could include a latch that could engage with the finger trap when the finger trap was rotated around the hinge. This could provide a secure orientation for the finger trap when it was being held, and also serve to lock in a clipping target between the clip anchor, clip, and latch when the attached device was secured. In specific embodiments of the invention in which the clipping device included a case, the latch could be formed on the back side of the case.

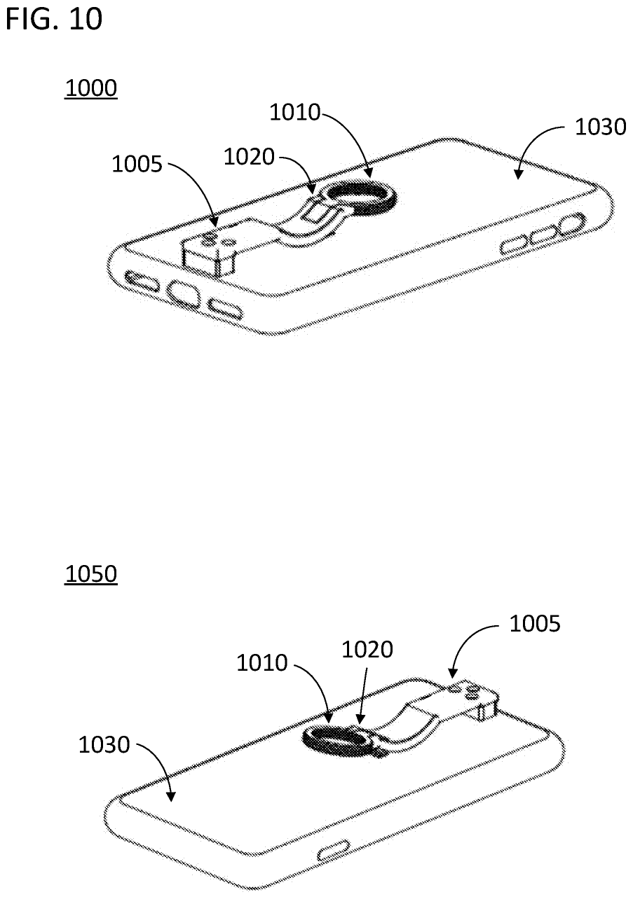

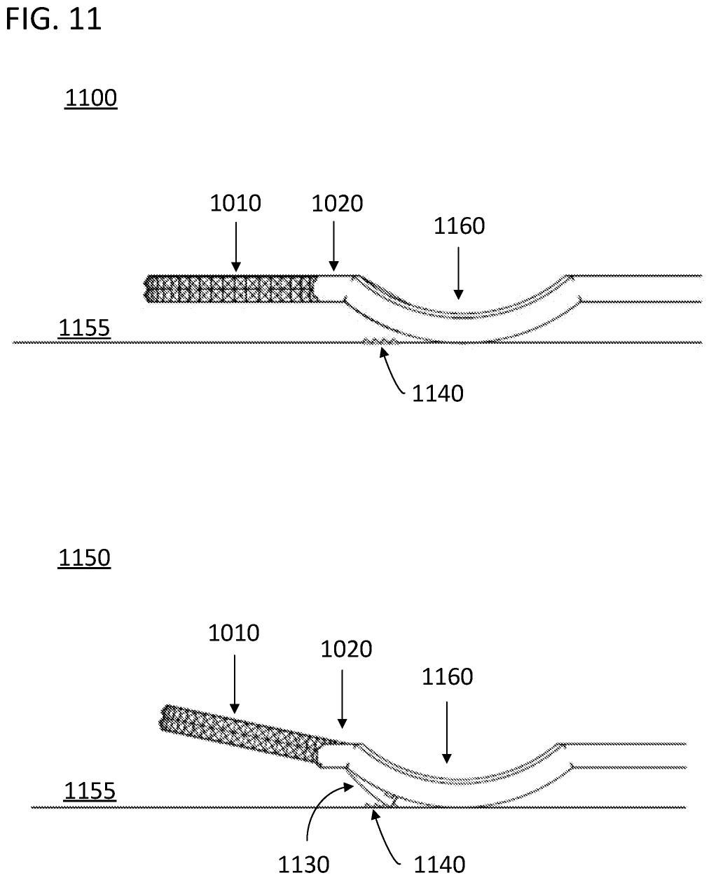

FIGS. 10 and 11 provide an example of a clip 1005 with a hinged finger trap 1010 that can lock the device to a clipping target such as a belt or webbing system. FIG. 10 includes two views of the clip 1005 before (1000) and after (1050) the finger trap 1010 has been rotated around the hinge (1020). As shown, one edge of the finger trap 1010 is extending downward towards the back surface of the case 1030. FIG. 11 provides a close-up of the two views in FIG. 10 from a side perspective, before (1100) and after (1150) the finger trap 1010 has been rotated around the hinge (1020). As seen in FIG. 11, when the finger trap 1010 has been rotated through the hinge 1020, an extension 1130 protrudes downward into a latch 1140 formed on the back side of the device or case 1155. The latch 1140 and extension 1130 on the finger trap 1010 can form a friction or compression seal. As such, the extension 1130 will close off the clipping target from slipping out below the depression 1160 and the attached device will be secured to the clipping target. The extension can be configured to form a friction or compression seal with the clip when it has not been rotated around the hinge to keep it from getting in the way as the attached device is clipped or unclipped.

In specific embodiments of the invention, the clip will include other purposes besides serving as a clip and finger trap. For example, the clip could serve as a connection for a mounting device designed to operate with the clipping device or a kickstand to prop the attached device up. The entire clip could be hinged to allow the clip to swing out and away from the clipping surface to serve as a kickstand (i.e., the clip could be a hinged clip). The hinge for the clip could include a catch or lock to assure that the hinge did not inadvertently open and disrupt the tension maintained by the clip against the clipping surface when the clip was not being used as a stand. As another example, the finger trap of the clip could be used as a mounting point for a stand. If the clip and finger trap were ferrous, the mounting device could include a magnet with a shape designed to interoperate with the finger trap. For example, if the finger trap was circular, the mounting device could include a magnetic half dome with a radius equal to or slightly larger than the internal radius of the ring to allow the clip and attached device to rest thereon. For example, a magnetic mount could include a sphere or semi-sphere where the ring of the finger trap can securely rest on in different positions. In another example, the clip could include a hole to be used as a cradle mount. The hole and finger trap could then be used in combination with the cradle mount. For example, the cradle mount could include a hook designed to interface with an edge of the finger trap and a protrusion configured to go through the second hole to form a compression or friction seal. Placing the device on the cradle mount would thereby involve hooking the hook onto the finger trap and pressing the protrusion into the second hole to click it into place. In other embodiments, a small elastic strap such as a mini-bungee cord could be connected between the second hole and the finger trap and the mounting device could be a handle bar around which the elastic strap could be wrapped to mount the device.

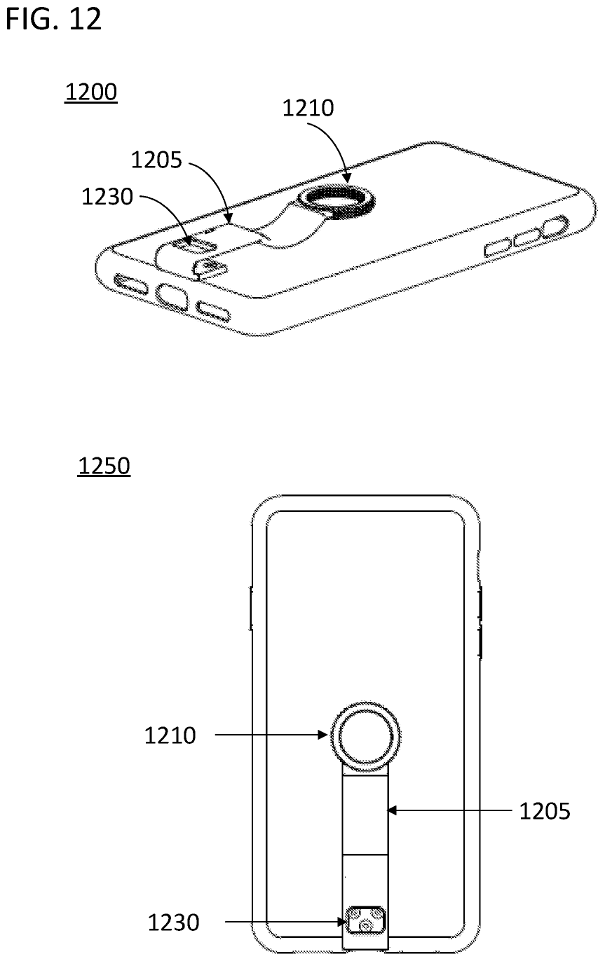

FIG. 12 includes views 1200 and 1250 of an example of a clip 1205 configured to mate with a mounting device. As illustrated, the clip 1205 includes a second hole 1230 proximate the anchor and a finger trap 1210 in the shape of a loop. A hook on the mounting device could be sized to mate with the loop. The second hole 1230 could be sized and spaced apart from the finger trap 1210 to mate with a protrusion on the mounting device. The protrusion could be a wedge-shaped spring bolt to go through the second hole 1230. Placing the device on the cradle mount would thereby involve hooking the hook onto the finger trap 1210 and pressing the spring bolt into the second hole 1230 to click it into place.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure included the use of a case to attach the clip to the attached device, in any of the examples provided, the case can be substituted with any device capable of adhering to the attached device such as an adjustable bracket, bag, clip, strap, or the like. Although examples in the disclosure were generally directed to mobile electronic devices such as smartphones, the same approaches could be utilized to provide a handle clip for any attached device such as knives, flashlights, compasses, or any other equipment. These and other modifications and variations to the present invention may be practiced by those skilled in the art, without departing from the scope of the present invention, which is more particularly set forth in the appended claims.

What is claimed is:

1. A clipping device comprising:
a clip connected to a mobile electronic device and configured to maintain tension towards a clipping surface; and
a finger trap integrated with the clip.

2. The clipping device of claim 1, further comprising:
an enclosed area defined by the finger trap;
wherein the finger trap forms at least a partial enclosure around the enclosed area; and
wherein the partial enclosure does not have any breaks in excess of one centimeter.

3. The clipping device of claim 2, further comprising:
an enclosed volume defined by the enclosed area and the mobile electronic device;
wherein the enclosed volume is at least 0.7 centimeters deep from a top surface of the finger trap to the mobile electronic device.

4. The clipping device of claim 2, wherein:
the finger trap is spaced apart from the mobile electronic device by at least 0.5 centimeters.

5. The clipping device of claim 2, wherein:
the finger trap and clip are a unitary element.

6. The clipping device of claim 5, wherein:
the finger trap and clip are metallic.

7. The clipping device of claim 1, further comprising:
an enclosed area defined by the finger trap;
wherein the finger trap forms a continuous enclosure around the enclosed area.

8. The clipping device of claim 7, wherein:
the finger trap is a ring.

9. The clipping device of claim 1, wherein:
the finger trap is a textured ring.

10. The clipping device of claim 1, wherein the clip further comprises:
an anchor;
an elastic cantilever attached to the anchor and extending away from the anchor; and
wherein the clip maintains tension via the elastic cantilever and anchor.

11. The clipping device of claim 10, wherein the clip further comprises:
a depression on the elastic cantilever; and
the depression is in the direction of the clipping surface.

12. The clipping device of claim 1, wherein the clip further comprises:
a spring;
wherein the clip is an alligator clip; and
wherein the clip maintains tension via the spring.

13. The clipping device of claim 1, further comprising:
a case for the mobile electronic device;
an anchor attached to the clip;
wherein the clip is connected to the mobile electronic device via the case and anchor; and
wherein the anchor is connected to the case via an adhesive.

14. The clipping device of claim 1, further comprising:
an anchor attached to the clip;
a curve in the clip;
a distal end of the clip;
wherein the curve extends away from the anchor in a first direction; and
wherein the distal end of the clip extends away from the anchor in a direction opposite the first direction.

15. The clipping device of claim 1, further comprising:
a magnetic mount for the clipping device; and
wherein the magnetic mount includes a sphere or semi-sphere.

16. The clipping device of claim 1, further comprising:
a mount for the clipping device;
a hole in the clip; and
wherein the mount connects to the clipping device via the hole.

17. The clipping device of claim 1, further comprising:
a hinge connecting the finger trap to the clip.

18. The clipping device of claim 17, further comprising:
a case for the mobile electronic device;
a latch on a back side of the case;
wherein the clip is connected to the mobile electronic device via the case; and
wherein the finger trap engages with the latch when the finger trap is rotated around the hinge.

19. A clipping device comprising:
an adhesive clip anchor for attaching the clipping device to an attached device;
a hinged clip attached to the adhesive clip anchor; and
a finger trap integrated with the hinged clip.

20. The clipping device of claim 19, further comprising:
a lock configured to assure a hinge of the hinged clip does not disrupt tension of the hinged clip against a clipping surface.

21. The clipping device of claim 19, wherein:
the finger trap and hinged clip are a unitary element.

22. The clipping device of claim 19, further comprising:
an enclosed area defined by the finger trap;
wherein the finger trap forms a continuous enclosure around the enclosed area.

23. The clipping device of claim 19, wherein the clip further comprises:
an elastic cantilever attached to the adhesive clip anchor and extending away from the adhesive clip anchor; and
wherein the clip maintains tension via the elastic cantilever and anchor against a clipping surface.

24. The clipping device of claim 23, wherein the clip further comprises:
a depression on the elastic cantilever; and
the depression is in the direction of the clipping surface.

25. A clipping device comprising:
a clip, having a finger trap integrated with the clip; and
wherein the clip is configured to: (i) be attached to a clipping surface; (ii) maintain tension towards the clipping surface; and (iii) secure a clip target between the clip and the clipping surface.
